(19) United States
(12) Patent Application Publication
(10) Pub. No.: US 2024/0339655 A1
(43) Pub. Date: Oct. 10, 2024

(54) ALL-SOLID-STATE BATTERY WITH REDUCED INTERFACIAL RESISTANCE

(71) Applicants: Hyundai Motor Company, Seoul (KR); Kia Corporation, Seoul (KR)

(72) Inventors: Dong Hyun KIM, Saha-gu (KR); Ju Yeon Lee, Buk-gu (KR); Jae Hyeon Rim, Hwaseong-di (KR); Yoon Jae Han, Uiwang-si (KR); Chang Young Choi, Seoul (KR); Sang Mo Kim, Hwaseong-si (KR); Yoon Gon Kim, Dong-gu (KR)

(21) Appl. No.: 18/456,120

(22) Filed: Aug. 25, 2023

(30) Foreign Application Priority Data
Apr. 6, 2023 (KR) 10-2023-0045134

(51) Int. Cl. H01M 10/0562

(52) U.S. Cl. CPC H01M 10/0562; H01M 2300/0068

(57) ABSTRACT

An all-solid-state battery according to the present disclosure includes a cathode layer comprising a cathode active material, an anode layer comprising an anode active material, and a solid electrolyte layer interposed between the cathode layer and the anode layer. The solid electrolyte layer includes a core layer part comprising a first solid electrolyte, a surface layer part disposed on at least one surface of the core layer part, and a second solid electrolyte. An average particle diameter (D50) of the first solid electrolyte is greater than an average particle diameter (D50) of the second solid electrolyte.

### CROSS-REFERENCE TO RELATED APPLICATION

This application claims, under 35 U.S.C. § 119(a), the benefit of priority from Korean Patent Application No. 10-2023-0045134, filed on Apr. 6, 2023, the entire contents of which are incorporated herein by reference.

### TECHNICAL FIELD

The present disclosure relates to an all-solid-state battery with reduced interfacial resistance.

### BACKGROUND

With occurrence of environmental problems such as climate change, the proportion of electric vehicles equipped with lithium ion batteries using liquid electrolytes is increasing. However, batteries using liquid electrolytes have a risk of fire and explosion, and thus development of all-solid-state batteries including solid electrolytes in place of liquid electrolytes is being actively conducted.

An all-solid-state battery includes a cathode, a solid electrolyte layer, and an anode. Since each component of the all-solid-state battery is in a solid state, there are many considerations to be made, such as resistance at the interface between layers, lithium ion conductivity of the solid electrolyte layer, water stability in processes, flexibility of the solid electrolyte layer, and the like.

### SUMMARY OF THE DISCLOSURE

An object of the present disclosure is to provide an all-solid-state battery in which interfacial resistance between layers is reduced.

Another object of the present disclosure is to provide an all-solid-state battery with excellent water stability.

The objects of the present disclosure are not limited to the foregoing. The objects of the present disclosure will be able to be clearly understood through the following description and to be realized by the means described in the claims and combinations thereof.

An implementation of the present disclosure provides an all-solid-state battery including a cathode layer including a cathode active material, an anode layer including an anode active material, and a solid electrolyte layer interposed between the cathode layer and the anode layer, in which the solid electrolyte layer may include a core part including a first solid electrolyte and a surface layer part disposed on at least one side of the core part and including a second solid electrolyte, and an average particle diameter (D50) of the first solid electrolyte may be greater than an average particle diameter (D50) of the second solid electrolyte.

The thickness of the core part may be 10 μm to 50 μm.

The first solid electrolyte may include at least one selected from the group consisting of an oxide-based solid electrolyte, a sulfide-based solid electrolyte, and combinations thereof.

The first solid electrolyte may include at least one selected from the group consisting of a crystalline solid electrolyte, an amorphous solid electrolyte, and combinations thereof.

The average particle diameter (D50) of the first solid electrolyte may be 2 μm to 5 μm.

The thickness of the surface layer part may be 0.5 μm to 2 μm.

The average particle diameter (D50) of the second solid electrolyte may be 0.1 μm to 1 μm.

The second solid electrolyte may include at least one selected from the group consisting of an oxide-based solid electrolyte, a sulfide-based solid electrolyte, and combinations thereof.

The second solid electrolyte may include at least one selected from the group consisting of a crystalline solid electrolyte, an amorphous solid electrolyte, and combinations thereof.

The solid electrolyte layer may further include a binder.

The binder may include at least one selected from the group consisting of butadiene rubber, nitrile butadiene rubber, hydrogenated nitrile butadiene rubber, polyvinylidene fluoride, polytetrafluoroethylene, and combinations thereof.

The cathode layer may include a first interface portion that is a region ranging from a main surface in contact with the solid electrolyte layer to a predetermined depth in a thickness direction, and the first interface portion may include a cathode active material having an average particle diameter (D50) of about 5 μm to 20 μm.

The thickness of the first interface portion may be about 10 μm to 30 μm.

The anode layer may include a second interface portion that is a region ranging from a main surface in contact with the solid electrolyte layer to a predetermined depth in a thickness direction, and the second interface portion may include an anode active material having an average particle diameter (D50) of about 5 μm to 20 μm.

The thickness of the second interface portion may be about 10 μm to 30 μm.

### BRIEF DESCRIPTION OF THE DRAWINGS

The above and other features of the present disclosure will now be described in detail with reference to certain exemplary implementations thereof illustrated in the accompanying drawings, which are given hereinbelow by way of illustration only, and thus are not limitative of the present disclosure, and wherein:

FIG. 1 shows an example all-solid-state battery according to the present disclosure;

FIG. 2 shows an example solid electrolyte layer according to the present disclosure;

FIG. 3 shows an example cathode layer according to the present disclosure; and

FIG. 4 shows an example anode layer according to the present disclosure.

### DETAILED DESCRIPTION

The above and other objects, features and advantages of the present disclosure will be more clearly understood from the following preferred implementations taken in conjunction with the accompanying drawings. However, the present disclosure is not limited to the implementations disclosed herein, and may be modified into different forms. These implementations are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

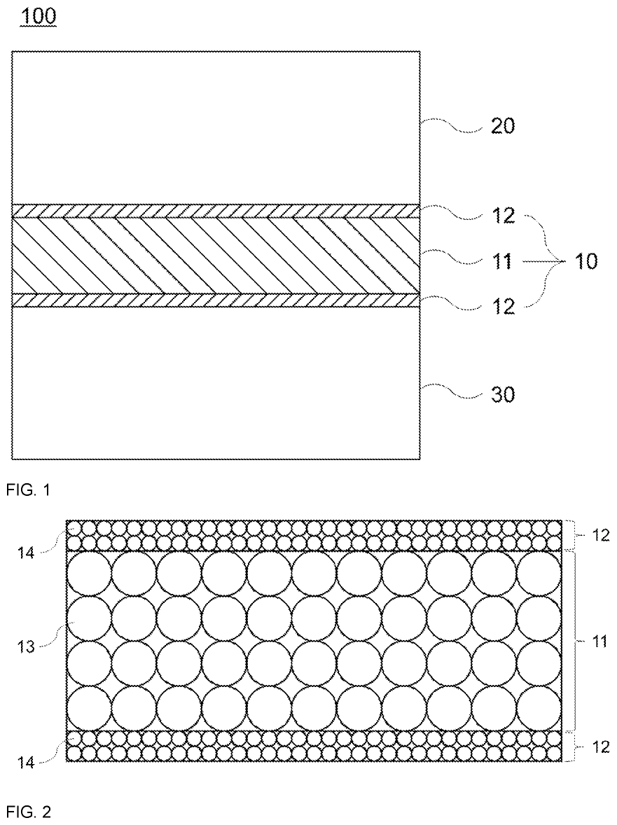

FIG. 1 shows an all-solid-state battery 100 according to an implementation the present disclosure. The all-solid-state battery 100 may include a solid electrolyte layer 10, a cathode layer 20 disposed on one surface of the solid electrolyte layer 10, and an anode layer 30 disposed on the opposite surface of the solid electrolyte layer 10.

FIG. 2 shows the solid electrolyte layer 10 according to an implementation of the present disclosure. The solid electrolyte layer 10 includes a core layer part 11 including a first solid electrolyte 13, and a surface layer part 12 disposed on at least one surface of the core layer part 11 and including a second solid electrolyte 14.

The solid electrolyte layer of a typical all-solid-state battery is generally composed of only one type of solid electrolyte. That is, solid electrolytes making up the solid electrolyte layer generally have the same particle size, composition, etc. As such, if a solid electrolyte having a small average particle diameter (D50) and a large specific surface area is used, the area in contact with the electrode layer may be enlarged, thereby reducing interfacial resistance. However, when the solid electrolyte layer is manufactured in an environment such as a dry room where water is not completely removed, many side reactions with water may occur due to a large specific surface area of the solid electrolyte, deteriorating battery performance. On the other hand, if a solid electrolyte having a large average particle diameter (D50) and a small specific surface area is used, stability against water may be improved, but when the battery is rolled due to a difference in size from the electrode active material, voids may be formed between the solid electrolyte layer and the electrode layer, causing problems such as poor contact, increased interfacial resistance, and the like.

In the present disclosure, the first solid electrolyte 13 included in the core layer part 11 has a relatively larger average particle diameter (D50), and the second solid electrolyte 14 included in the surface layer part 12 in contact with the cathode layer 20 and/or the anode layer 30 has a relatively smaller average particle diameter (D50), thus increasing water stability of the solid electrolyte layer 10 and decreasing interfacial resistance between the solid electrolyte layer 10 and the cathode layer 20 and/or the anode layer 30.

In the core layer part 11, the first solid electrolyte 13 may exist in the form of particles, or the particles may exist in a dense form under predetermined pressure. When the particles exist in a dense form, there may be interfaces between the particles. When the first solid electrolyte 13 exists in the form of particles, the average particle diameter (D50) of the first solid electrolyte 13 may be a physical property of the particles. When the first solid electrolyte 13 exists in a dense form, the average particle diameter (D50) of the first solid electrolyte 13 may be a physical property of any one region of the particle form separated from other regions by the interfaces.

An average particle diameter (D50) of the first solid electrolyte 13 may be about 2 μm to 5 μm, or about 3 μm to 4 μm. If the average particle diameter (D50) of the first solid electrolyte 13 is less than 2 μm, the specific surface area may be enlarged, and thus water stability of the solid electrolyte layer 10 may be deteriorated. The average particle diameter (D50) of the first solid electrolyte 13 may be a volume-converted median diameter measured using a laser-type particle size distribution analyzer.

The first solid electrolyte 13 may include at least one selected from the group consisting of an oxide-based solid electrolyte, a sulfide-based solid electrolyte, and combinations thereof. Moreover, the first solid electrolyte 13 may be a crystalline solid electrolyte, an amorphous solid electrolyte, or a mixture thereof.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (in which m and n are positive numbers and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers and M is any one selected from among P, Si, Ge, B, Al, Ga, and In), Li₁₀GeP₂S₁₂, and the like.

In some implementations, the first solid electrolyte 13 may include a sulfide-based solid electrolyte having an argyrodite crystal structure. The sulfide-based solid electrolyte having the argyrodite crystal structure may include at least one selected from the group consisting of Li₇₋ₓPS₆₋ₓClₓ (0<x≤2), Li₇₋ₓPS₆₋ₓBrₓ (0<x≤2), Li₇₋ₓPS₆₋ₓIₓ (0<x≤2), and combinations thereof.

In the surface layer part 12, the second solid electrolyte 14 may exist in the form of particles, or the particles may exist in a dense form under predetermined pressure. When the particles exist in a dense form, there may be interfaces between the particles. When the second solid electrolyte 14 exists in the form of particles, the average particle diameter (D50) of the second solid electrolyte 14 may be a physical property of the particles. When the second solid electrolyte 14 exists in a dense form, the average particle diameter (D50) of the second solid electrolyte 14 may be a physical property of any one region of the particle form separated from other regions by the interfaces.

The average particle diameter (D50) of the second solid electrolyte 14 may be about 20% or less of the average particle diameter (D50) of the first solid electrolyte 13. Specifically, the average particle diameter (D50) of the second solid electrolyte 14 may be about 0.1 μm to 1 μm. If the average particle diameter (D50) of the second solid electrolyte 14 exceeds 1 μm, interfacial contact between the surface layer part 12 and the cathode layer 20 and/or the anode layer 30 may deteriorate. The average particle diameter (D50) of the second solid electrolyte 14 may be a volume-converted median diameter measured using a laser-type particle size distribution analyzer.

The second solid electrolyte 14 may include at least one selected from the group consisting of an oxide-based solid electrolyte, a sulfide-based solid electrolyte, and combinations thereof. Moreover, the second solid electrolyte 14 may be a crystalline solid electrolyte, an amorphous solid electrolyte, or a mixture thereof. The second solid electrolyte 14 may have the same or different composition or crystallinity from the first solid electrolyte 13.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers and M is any one selected from among P, Si, Ge, B, Al, Ga, and In), Li₁₀GeP₂S₁₂, and the like.

In some implementations, the second solid electrolyte 14 includes a sulfide-based solid electrolyte having an argyrodite crystal structure. The sulfide-based solid electrolyte having the argyrodite crystal structure may include at least one selected from the group consisting of Li₇₋ₓPS₆₋ₓClₓ (0<x≤2), Li₇₋ₓPS₆₋ₓBrₓ (0<x≤2), Li₇₋ₓPS₆₋ₓIₓ (0<x≤2), and combinations thereof.

The core layer part 11 may have a thickness of about 10 μm to 50 μm. If the thickness of the core layer part 11 is less than 10 μm, durability of the all-solid-state battery 100 may deteriorate, whereas if it exceeds 50 μm, the energy density per volume of the all-solid-state battery 100 may decrease.

The surface layer part 12 may have a thickness of about 0.5 μm to 2 μm. If the thickness of the surface layer part 12 is less than 0.5 μm, interfacial contact between the solid electrolyte layer 10 and the cathode layer 20 and/or the anode layer 30 may not be good, whereas if it exceeds 2 μm, water stability of the solid electrolyte layer 10 may be deteriorated.

The solid electrolyte layer 10 may further include a binder. The binder may include at least one selected from the group consisting of butadiene rubber, nitrile butadiene rubber, hydrogenated nitrile butadiene rubber, polyvinylidene fluoride, polytetrafluoroethylene, and combinations thereof.

A method of manufacturing the solid electrolyte layer 10 is not particularly limited. For example, the method may include manufacturing the core layer part 11 and manufacturing the surface layer part 12 on at least one surface of the core layer part 11.

Manufacturing the core layer part 11 may include preparing a slurry including the first solid electrolyte 13, a binder, and a solvent, applying the slurry onto a substrate, and drying the slurry.

Here, any suitable solvent may be included, so long as it does not react with the first solid electrolyte 13. Examples of the solvent may include a non-polar organic solvent, an aprotic organic solvent, and the like. Specifically, the solvent may include at least one selected from the group consisting of toluene, chloroform, ethyl acetate, 1,2-dimethoxyethane, tetrahydrofuran (THF), methylene chloride, pyridine, 2-butanone, acetone, N-methylpyrrolidinone, acetonitrile, sulfolane, dimethyl sulfoxide, carbon tetrachloride, hexane, heptane, pentane, decalin, dioxane, and combinations thereof.

Manufacturing the surface layer part 12 may include preparing a slurry including the second solid electrolyte 14, a binder, and a solvent, applying the slurry onto at least one surface of the core layer part 11, and drying the slurry. However, manufacturing the surface layer part 12 is not limited to directly applying the slurry onto the core layer part 11, and the surface layer part 12 obtained by applying the slurry onto a release paper followed by drying may be transferred onto the core layer part 11.

In other implementations, the method of manufacturing the solid electrolyte layer 10 is not limited to the aforementioned wet method and may be performed through a dry method that does not use a solvent.

The cathode layer 20 may include a cathode active material, a solid electrolyte, a conductive material, a binder, a dispersant, and the like.

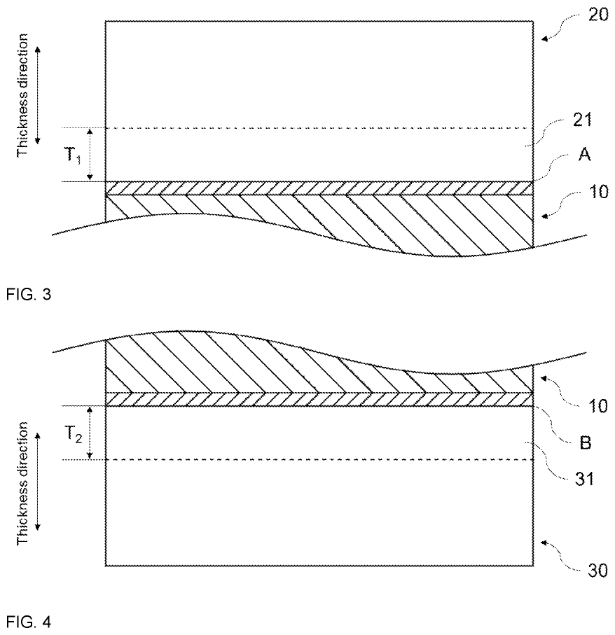

FIG. 3 shows the cathode layer 20. The cathode layer 20 may include a first interface portion 21 that is a region ranging from the main surface A in contact with the solid electrolyte layer 10 to a predetermined depth in a thickness direction. The thickness T₁ of the first interface portion 21 may be about 10 μm to 30 μm.

In the present disclosure, the average particle size (D50) of the cathode active material included in the first interface portion 21 in contact with the surface layer part 12 is adjusted not to be too large compared to the second solid electrolyte 14, so that the interface between the solid electrolyte layer 10 and the cathode layer 20 may be formed well.

The average particle diameter (D50) of the cathode active material included in the first interface portion 21 may be about 5 μm to 20 μm, or about 7 μm to 15 μm. If the average particle diameter (D50) of the cathode active material exceeds 20 μm, voids may be formed at the interface between the solid electrolyte layer 10 and the cathode layer 20, resulting in poor contact.

The cathode active material may be capable of occluding and releasing lithium ions.

The cathode active material may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one selected from among Al, Mg, Co, Fe, Ni and Zn, 0<x+y<2), lithium titanate such as Li₄Ti₅O₁₂, and the like.

The anode layer 30 may include an anode active material, a solid electrolyte, a conductive material, a binder, a dispersant, and the like.

FIG. 4 shows the anode layer 30. The anode layer 30 may include a second interface portion 31 that is a region ranging from the main surface B in contact with the solid electrolyte layer 10 to a predetermined depth in a thickness direction. The thickness T₂ of the second interface portion 31 may be about 10 μm to 30 μm.

In the present disclosure, the average particle size (D50) of the anode active material included in the second interface portion 31 in contact with the surface layer part 12 is adjusted not to be too large compared to the second solid electrolyte 14, so that the interface between the solid electrolyte layer 10 and the anode layer 30 may be formed well.

The average particle diameter (D50) of the anode active material included in the second interface portion 31 may be about 5 μm to 20 μm, or about 7 μm to 15 μm. If the average particle diameter (D50) of the anode active material exceeds 20 μm, voids may be formed at the interface between the solid electrolyte layer 10 and the anode layer 30, resulting in poor contact.

The anode active material may include at least one selected from the group consisting of a carbon-based active material, a silicon-based active material, and combinations thereof.

The carbon-based active material may include natural graphite, artificial graphite, and the like.

The silicon-based active material may include Si, SiOₓ (0<x<2), and the like.

A better understanding of the present disclosure may be obtained through the following examples. These examples are merely set forth to illustrate the present disclosure, and are not to be construed as limiting the scope of the present disclosure.

### EXAMPLES

As a first solid electrolyte, a sulfide-based solid electrolyte having an average particle diameter (D50) of 3 μm to 4 μm, an argyrodite crystal structure, and represented by Li₆PS₅Cl was prepared.

As a second solid electrolyte, a sulfide-based solid electrolyte having an average particle diameter (D50) of 1 μm or less, an argyrodite crystal structure, and represented by Li₆PS₅Cl was prepared.

A core layer part was manufactured by applying a first slurry including the first solid electrolyte, a binder, and a solvent onto a substrate, followed by drying. The binder that was used was butadiene rubber.

A surface layer part was manufactured by applying a second slurry including the second solid electrolyte, a binder, and a solvent onto each of both sides of the core layer part, followed by drying.

A solid electrolyte layer was obtained by pressing the laminate manufactured above. The thickness of the core layer part was about 10 μm, and the thickness of the surface layer part was about 0.5 μm to 2 μm.

An all-solid-state battery was manufactured by stacking a cathode layer containing a cathode active material on one side of the solid electrolyte layer and an anode layer containing an anode active material on the remaining side thereof.

### Comparative Example 1

As a solid electrolyte, a sulfide-based solid electrolyte having an average particle diameter (D50) of 1 μm or less, an argyrodite crystal structure, and represented by Li₆PS₅Cl was prepared.

A solid electrolyte layer was manufactured by applying a slurry containing the solid electrolyte, a binder, and a solvent onto a substrate, followed by drying and pressing. The thickness of the solid electrolyte layer was adjusted to be the same as that of the solid electrolyte layer of Example 1.

An all-solid-state battery was manufactured by stacking the same cathode and anode layers as in Example 1 on respective sides of the solid electrolyte layer.

### Comparative Example 2

As a solid electrolyte, a sulfide-based solid electrolyte having an average particle diameter (D50) of 3 μm to 4 μm, an argyrodite crystal structure, and represented by Li₆PS₅Cl was prepared.

A solid electrolyte layer was manufactured by applying a slurry containing the solid electrolyte, a binder, and a solvent onto a substrate, followed by drying and pressing. The thickness of the solid electrolyte layer was adjusted to be the same as that of the solid electrolyte layer of Example 1.

An all-solid-state battery was manufactured by stacking the same cathode and anode layers as in Example 1 on respective sides of the solid electrolyte layer.

The all-solid-state batteries according to Example 1, Comparative Example 1, and Comparative Example 2 were analyzed by electrochemical impedance spectroscopy, and charge transfer resistance of each all-solid-state battery was measured. The results thereof are shown in Table 1 below.

TABLE 1

| | | Comparative | Comparative |
|---|---|---|---|
| Item | Example 1 | Example 1 | Example 2 |
| Charge transfer resistance (R_{ct}) | 2.8 Ω | 3.2 Ω | 2.5 Ω |

Example 1 including the core layer part and the surface layer part showed low charge transfer resistance compared to Comparative Example 1 using only the solid electrolyte having a small average particle diameter (D50). Thereby, it can be found that the core layer part of Example 1 included a solid electrolyte having a large average particle diameter (D50) and thus high water stability, so that battery performance was not deteriorated during the manufacturing process.

### Comparative Example 3

A solid electrolyte layer and an all-solid-state battery including the same were manufactured in the same manner as in Example 1, with the exception that the thickness of the surface layer part was adjusted to be less than 0.5 μm.

### Comparative Example 4

A solid electrolyte layer and an all-solid-state battery including the same were manufactured in the same manner as in Example 1, with the exception that the thickness of the surface layer part was adjusted to be greater than 2 μm.

### Comparative Example 5

A solid electrolyte layer and an all-solid-state battery including the same were manufactured in the same manner as in Example 1, with the exception that a first solid electrolyte having an average particle diameter (D50) of less than 3 μm was used.

### Comparative Example 6

A solid electrolyte layer and an all-solid-state battery including the same were manufactured in the same manner as in Example 1, with the exception that a first solid electrolyte having an average particle diameter (D50) of greater than 4 μm was used.

The capacity retention rate was measured when the all-solid-state batteries according to Example 1 and Comparative Examples 2 to 6 were charged and discharged 30 cycles. The results thereof are shown in Table 2 below.

TABLE 2

| | | | Average particle | Capacity |
|---|---|---|---|---|
| | Presence of | Thickness of | diameter of first | retention |
| Classifi- | surface | surface layer | solid electrolyte | rate @30 |
| cation | layer part | part | (D50) | cycles |
| Example 1 | ◯ | 0.5-2 μm | 3-4 μm | 90% |
| Comparative | X | — | 3-4 μm | 65% |
| Example 2 | | | | |
| Comparative | ◯ | Less than | 3-4 μm | 82% |
| Example 3 | | 0.5 μm | | |
| Comparative | ◯ | Greater than | 3-4 μm | 81% |
| Example 4 | | 2 μm | | |
| Comparative | ◯ | 0.5-2 μm | Less than | 85% |
| Example 5 | | | 3 μm | |
| Comparative | ◯ | 0.5-2 μm | Greater than | 87% |
| Example 6 | | | 4 μm | |

Example 1, which satisfies the thickness of the surface layer part and the average particle diameter (D50) of the first solid electrolyte that make up the core layer part, according to the present disclosure, showed a capacity retention rate of about 90%. In contrast, Comparative Example 2 in which the surface layer part was not formed exhibited a very low capacity retention rate of 65%. This is attributed to the interface between the solid electrolyte layer and the electrode layer not being formed well in Comparative Example 2. In Comparative Example 3, the thickness of the surface layer part was less than that of Example 1, so that the interfacial resistance between the solid electrolyte layer and the electrode layer was not reduced, and thus the capacity retention rate was measured to be low. In Comparative Example 4, the thickness of the surface layer part was greater than that of Example 1, and accordingly, the core layer part was relatively thin, resulting in poor water stability, and thus the capacity retention rate was determined to be low. In Comparative Example 5, since the first solid electrolyte having a small average particle diameter (D50) was used, water stability was problematic, resulting in a low capacity retention rate. In Comparative Example 6, the difference in average particle diameter (D50) between the first solid electrolyte and the second solid electrolyte was large, and thus voids were generated therebetween, resulting in a low capacity retention rate.

As is apparent from the above description, according to the present disclosure, an all-solid-state battery with reduced interfacial resistance between layers can be obtained.

According to the present disclosure, an all-solid-state battery having excellent water stability can be obtained.

According to the present disclosure, an all-solid-state battery having a long lifespan and excellent performance can be obtained.

The effects of the present disclosure are not limited to the above-mentioned effects. It should be understood that the effects of the present disclosure include all effects that can be inferred from the description of the present disclosure.

Although the present disclosure has been described in detail above, the scope of the present disclosure is not limited thereto, and various modifications and improvements made by those skilled in the art using the basic concept of the present disclosure defined in the following claims are also included in the scope of the present disclosure.

What is claimed is:

1. An all-solid-state battery, comprising:
a cathode layer comprising a cathode active material;
an anode layer comprising an anode active material; and
a solid electrolyte layer interposed between the cathode layer and the anode layer,
wherein the solid electrolyte layer comprises:
a core layer part comprising a first solid electrolyte; and
a surface layer part disposed on at least one surface of the core layer part, and comprising a second solid electrolyte; and
wherein an average particle diameter (D50) of the first solid electrolyte is greater than an average particle diameter (D50) of the second solid electrolyte.

2. The all-solid-state battery of claim 1, wherein a thickness of the core layer part is 10 μm to 50 μm.

3. The all-solid-state battery of claim 1, wherein the average particle diameter (D50) of the first solid electrolyte is 2 μm to 5 μm.

4. The all-solid-state battery of claim 1, wherein the first solid electrolyte comprises an oxide-based solid electrolyte, a sulfide-based solid electrolyte, or combinations thereof.

5. The all-solid-state battery of claim 1, wherein the first solid electrolyte comprises a crystalline solid electrolyte, an amorphous solid electrolyte, or combinations thereof.

6. The all-solid-state battery of claim 1, wherein a thickness of the surface layer part is 0.5 μm to 2 μm.

7. The all-solid-state battery of claim 1, wherein the average particle diameter (D50) of the second solid electrolyte is 0.1 μm to 1 μm.

8. The all-solid-state battery of claim 1, wherein the second solid electrolyte comprises an oxide-based solid electrolyte, a sulfide-based solid electrolyte, or combinations thereof.

9. The all-solid-state battery of claim 1, wherein the second solid electrolyte comprises a crystalline solid electrolyte, an amorphous solid electrolyte, or combinations thereof.

10. The all-solid-state battery of claim 1, wherein the solid electrolyte layer further comprises a binder.

11. The all-solid-state battery of claim 10, wherein the binder comprises butadiene rubber, nitrile butadiene rubber, hydrogenated nitrile butadiene rubber, polyvinylidene fluoride, polytetrafluoroethylene, or combinations thereof.

12. The all-solid-state battery of claim 1, wherein the cathode layer comprises a first interface portion that is a region ranging from a main surface in contact with the solid electrolyte layer to a predetermined depth in a thickness direction, and the first interface portion comprises the cathode active material having an average particle diameter (D50) of 5 μm to 20 μm.

13. The all-solid-state battery of claim 12, wherein a thickness of the first interface portion is 10 μm to 30 μm.

14. The all-solid-state battery of claim 1, wherein the anode layer comprises a second interface portion that is a region ranging from a main surface in contact with the solid electrolyte layer to a predetermined depth in a thickness direction, and the second interface portion comprises the anode active material having an average particle diameter (D50) of 5 μm to 20 μm.

15. The all-solid-state battery of claim 14, wherein a thickness of the second interface portion is 10 μm to 30 μm.
